(19) United States
(12) Patent Application Publication
(10) Pub. No.: US 2022/0071417 A1
(43) Pub. Date: Mar. 10, 2022

(54) POSITION CORRECTION PILLOW

(71) Applicant: Robin Loukota Baugh, Shalimar, FL (US)

(72) Inventor: Robin Loukota Baugh, Shalimar, FL (US)

(21) Appl. No.: 17/100,900

(22) Filed: Nov. 22, 2020

Related U.S. Application Data
(60) Provisional application No. 62/706,711, filed on Sep. 4, 2020.

(51) Int. Cl. A47G 9/10; A61G 7/07

(52) U.S. Cl. CPC A47G 9/10; A61G 7/072

(57) ABSTRACT

A support pillow to control involuntary muscle movement, during sleep or rest is provided. The support pillow includes a first lateral body; a second lateral body; and a horizontal central strap mechanically connected to the first lateral body and the second lateral body. The first lateral body and second lateral body further includes an inner layer and a plurality of pockets of a weighted material. The central strap gives flexibility to the first and second lateral bodies and does not restrict the person to any particular position throughout the sleep. The support pillow is also designed to receive the force or pressure created by the pull of the person's/user's body parts.

### CROSS-REFERENCE TO RELATED APPLICATION

The present application is entitled to priority under 35 U.S.C S 119(e), to U.S. Provisional Application No. 62/706,711, filed Sep. 4, 2020.

### BACKGROUND OF THE INVENTION

The popularity and widespread use of therapeutic pillows has risen in recent years. Therapeutic pillows are used not only for basic head, neck and upper back support during sleeping, but also to avoid painful conditions in which neck muscles contract involuntarily, causing the head to twist or turn to one side. These painful conditions often result due to various movement disorders such as cervical dystonia, spina bifida, Parkinson's disease, muscular dystrophy, tremor, Huntington's disease and the like.

A typical therapeutic pillow has a conventional cushion with a central cavity and two raised side panels to accommodate the shoulder height. Unfortunately, for some people it's challenging to control the tilt of body parts efficiently in this setting.

Involuntary neck muscle movement leads to twisting or turning of head to one side during sleeping which further leads a pillow to slide or move away from head or neck. Due to lack of muscle support during sleep, patients with movement disorders tend to have poor sleep quality and show impaired sleep architecture. Unfortunately, for some patients, involuntary movements and abnormal postures during sleep worsens pain. Hence, it is advisable to have efficient support to muscles to avoid muscle stiffness, headaches, pain and injuries.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a typical involuntary muscle movement episode with a tilt of body parts in a person with movement disorder.

FIG. 2 is a top perspective view illustrating a support pillow in accordance with some embodiments.

FIG. 3 is a top perspective view illustrating attachment of a first and second lateral bodies with a central strap in accordance with some embodiments.

FIG. 4 is a cross sectional view illustrating an inner configuration of a first lateral body taken along the line A-A of FIG. 1 in accordance with some embodiments.

FIG. 5 is a top perspective view illustrating a support pillow with a person using it in supine position in accordance with some embodiments.

FIG. 6 is a top perspective view illustrating a support pillow being used by a person in a side posture position.

FIG. 7 is a top perspective view illustrating the use of a support pillow in combination with conventional pillow in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An aspect of the specification provides a support pillow to control involuntary muscle movement, during sleep or rest. The support pillow includes a first lateral body, a second lateral body and a horizontal central strap mechanically connected to the first lateral body and the second lateral body. The first lateral body and second lateral body includes an inner layer and a plurality of pockets of a weighted material. The first lateral body and second lateral body further includes an upper side and a lower side. The horizontal central strap includes a horizontal body, a first end portion and a second end portion.

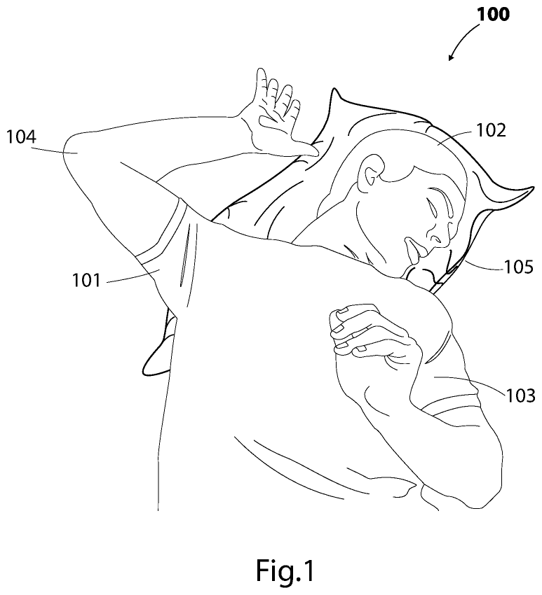

FIG. 1 illustrates a typical involuntary muscle movement episode 100 with a tilt of body parts in person 101 with movement disorders. As illustrated, a person 101 experiences an involuntary muscle movement episode 100 during sleep or rest. A head 102 of the patient 101 turns to one side with a shoulder pull up 103. The involuntary muscle movement episode 100 further causes twisting movements of a hand 104 which displaces a pillow 105. The pillow 105 moves along with body parts rather than controlling the involuntary movements. The movement disorders, for example may include cervical dystonia, spina bifida, Parkinson's disease, muscular dystrophy, tremor, Huntington's disease and the like. In some patient's involuntary muscle movement episode 100 may include muscle spasms may range from mild to severe stages. They may be painful and they may interfere with a patient's performance of day-to-day tasks. In some patients, the involuntary muscle movement episode 100 may be repetitive. The repetitive involuntary muscle movement may move away the pillow 105 from the head 102. Physicians provide guidelines suggesting the use of a pillow for neck and shoulder pain which may be firm enough to hold the body parts at a healthy angle, but soft enough to alleviate pressure points.

Involuntary muscle movement episodes can cause tingling, numbness and weakness in the arms, hands, legs or feet. Improper pillow or cushion support may aggravate these issues. In chronic muscle movement episodes due to cervical dystonia where the controlling of a repetitive tilt of a head and neck may be especially challenging. Conventional pillows with lack of support in recurring episodes and stabilization at one place make it harder to sleep efficiently. Some conventional pillows are rigid and do not allow for self-adjustment during rest. The rigidness of the pillow prevents efficient conformity to the user's neck and head.

It has been reported that a certain body position may be preferred or even required during sleep and rest for effective health recovery and/or health maintenance in person with movement disorders. For example, persons having cervical dystonia are more vulnerable to disruption of sleep when lying in a back or supine orientation during involuntary muscle movement episodes with lack of support to the body parts. In addition, relative physical positioning of parts of the body may be important, such as when one has a shoulder injury, spine misalignment, hip problem, etc. In short, a system or methodology of facilitating and controlling a healthier positional orientation during sleep or rest would be beneficial.

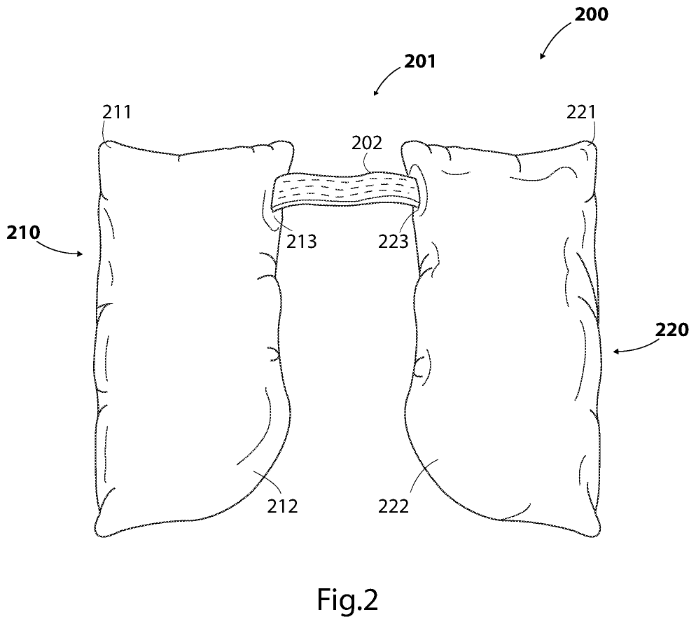

FIG. 2 is a top perspective view illustrating a support pillow 200 in accordance with some embodiments. In one embodiment, the support pillow 200 further includes a first lateral body 210, a second lateral body 220 and a central strap 201. The first lateral body 210 further includes an upper side 211 and a lower side 212. The second lateral body further includes an upper side 221 and a lower side 222. The central strap 201 is mechanically connected to the first 210 and second 220 lateral bodies. The lower sides 212 and 222 of the respective first lateral body 210 and second lateral 220 is designed to rest at the shoulder of a user.

In one embodiment, the lower sides 212 and 222 of the respective first lateral body 210 and second lateral 220 is designed to curve along the neck and head to form a secure placement. The first and second lateral bodies 210 and 220 may be made up of cushioning material selected from a group consisting of but not limited to expanded polystyrene (also Styrofoam), polypropylene, polyethylene, and polyurethane.

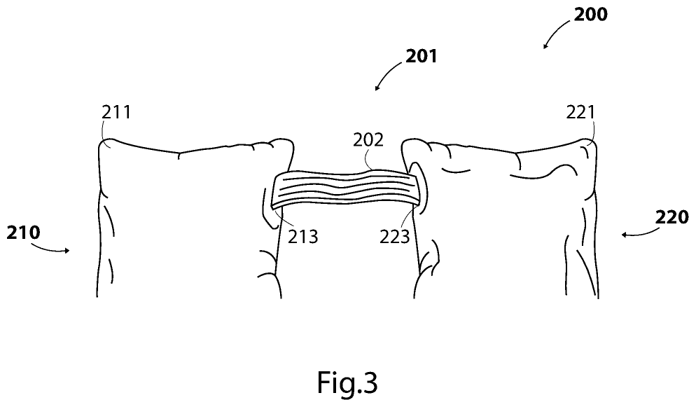

FIG. 3, is a top perspective view illustrating attachment of the first and second lateral bodies 210,220 with the central strap 201 in accordance with some embodiments. The central strap 201 further includes a horizontal body 202, a first end portion 213 and a second end portion 223. The horizontal body 202 of the central strap 201 is mechanically connected to the first lateral body 210 and the second lateral body 220. The first end portion 213 and a second end portion 223 of the central strap 201 is 4 mechanically connected near the upper side 211 and 221 of the respective lateral bodies 210,220. The distance between the upper sides 211,221 of the first 210 and second 220 lateral bodies and the first end portion 213 and a second end portion 223 of the central strap 201 may be customized to maintain the comfort. It will be appreciated by those of ordinary skill in the art that in one embodiment the central strap 201 comprises a permanent attachment such as a sewn, stapled, or other permanent attachment to mechanically connect the first end portion 213 and the second end portion 214 to the first and second lateral bodies 210,220. The horizontal body 202 of the central strap 201 may be made of single or multilayer washable product material such as cotton, polyester, copper fabric, quilting fabric and silk which may be easily cleaned.

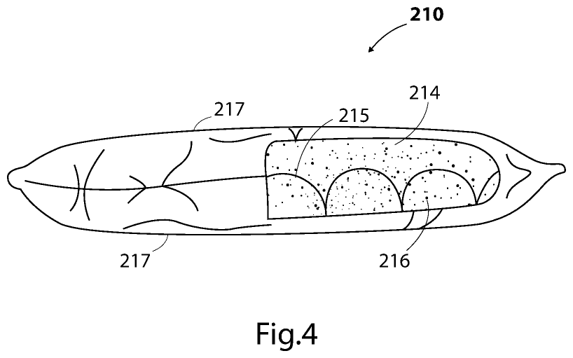

FIG. 4 is a cross sectional view illustrating the inner configuration of the first lateral body 210 taken along the line A-A of FIG. 1 in accordance with some embodiments. In one embodiment, the first lateral body 210 and second lateral body 220 are designed with the same inner and outer configuration. The first lateral body 210 further includes an outer cover 217, a top inner layer 214 and a plurality of pockets 215. As illustrated, the plurality of pockets 215 are designed to be placed underside of the top inner layer 214.

The top internal layer 214 is made up of a soft material. The soft material may be selected from a group consisting of but not limited to cotton, polyester, copper fabric, quilting fabric, wool, hair, feathers, polyester staple fiber, non-woven material. The plurality of pockets 215 each being filled with a weighted material 216. The plurality of pockets 215 are made up of material may be selected from product material from a group consisting of but not limited to cotton, polyester, copper fabric, quilting fabric, wool, hair, feathers, polyester staple fiber, non-woven material. The plurality of pockets 215 are designed to be placed underside of the top inner layer 214 and mechanically connected to the outer cover 217 of the first lateral body 210.

Referring to the FIG. 4 the plurality of pockets 215 prevents excessive amounts of weighted material 216 from being unevenly displaced or accumulated in any area of the first lateral body 210, which may create unsuitable mounds or uneven surfaces of the first lateral body 210. Thus, the overall shape of the first lateral body 210 is designed to remain uniform to improve the users' comfort. In some embodiments, the plurality of pockets 215 and the top inner layer 214 are allowed to run laterally along the entire length of the first lateral body 210, which permits the first lateral body 210 to maintain uniform configuration or shape. The weighted material 216 of the plurality of pockets 215 is designed to receive the force or pressure created by the pull of the person's/user's head and neck.

The weighted material may be selected from a group consisting of polyethylene, petrochemical plastics such as polypropylene, polystyrene and the like. The weighted material is designed to form a shape like a round or nearly round object or shape such as microbeads to maintain uniform stability throughout the first lateral body 210.

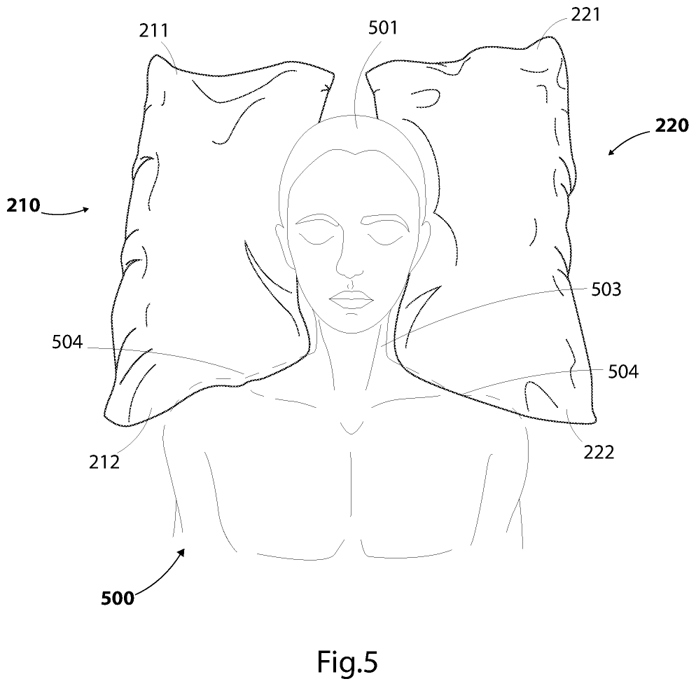

FIG. 5 is a top perspective view illustrating the support pillow 200 with a person 500 using it in supine position in accordance with some embodiments. The support pillow 200 supports a head 501 of the person 500 in a supine position by supporting a person's neck 503 and a shoulder 504 by aligning the first and second lateral bodies 210 and 220 in healthy angle.

In one embodiment, the first and second lateral bodies 210 and 220 support the left and right shoulder regions 504 and neck region 503 of the person 500 fits to maintain the healthy angle of the body during sleep or rest. The central strap 201 supports the first and second lateral bodies 210, 220 and further prevents displacement of the first and second lateral bodies 210, 220 during involuntary muscle movements. The central strap 201 is designed to retain the first and second lateral bodies 210, 220 in position and in communication with the left and right shoulder regions 504, neck region 503 and head 501 of the person 500. During the repetitive involuntary muscle movements, the inner configuration of the first and second lateral bodies 210, 220 and the central strap 201 supports the head 501 of the person 500 to control the body tilt efficiently.

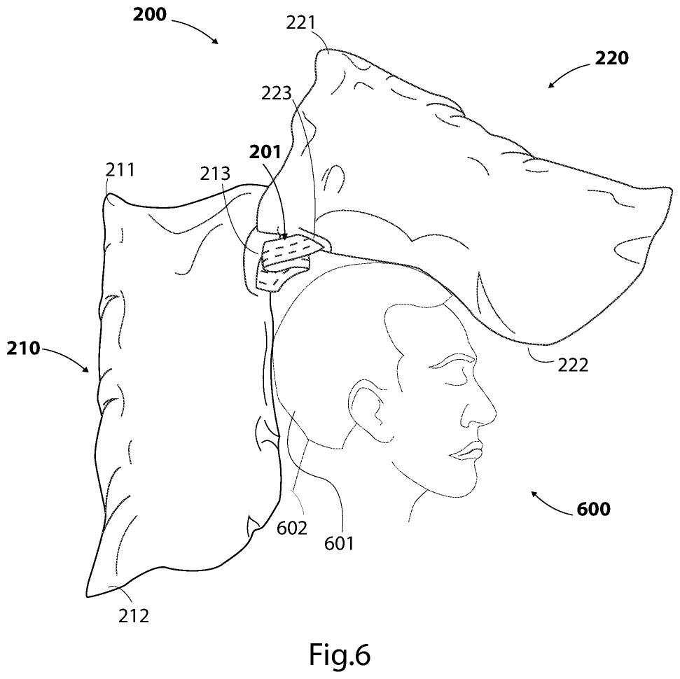

FIG. 6 is a top perspective view illustrating the support pillow 200 being used by a person 600 in a side posture position. As illustrated the person 600 is using the first lateral body 210 and the second lateral body 220 to support the head 601 to control the head tilt during sleep or rest. The central strap 201 is designed to adjust the use of first and second lateral bodies 210,220 to improve healthy position angle in suitable body posture. Due to the flexibility of the central strap 201 the person 600 can use the second lateral body 220 at any comfortable angle during side posture position. The flexibility of the central strap 201 also enhances the bending ability of the support pillow 200 and allows custom contour to the user's head and neck during rest.

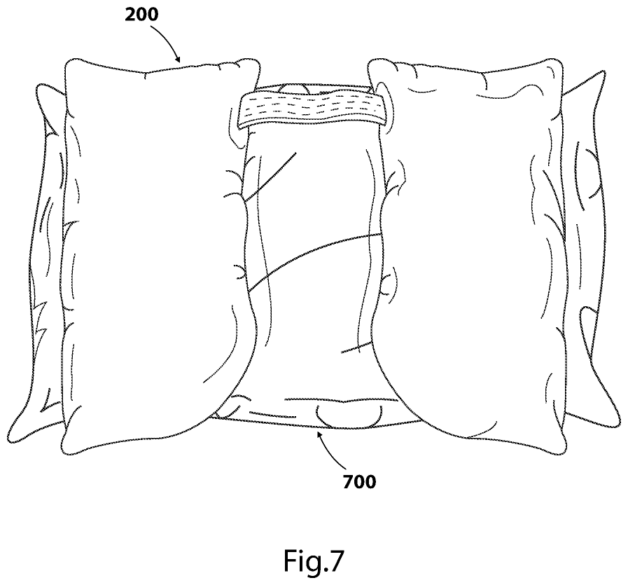

FIG. 7 is a top perspective view illustrating the use of the support pillow 200 in combination with a conventional pillow 700 in accordance with some embodiments. As illustrated, the support pillow 200 can be used in combination with a conventional pillow 700 to provide additional comfort and flexibility. In some embodiments, the conventional pillow 700 can be placed underside of the support pillow 200. Often the users of conventional pillows become attached to the top surface to which they have become accustomed. The flexibility of using the support pillow 200 in combination with the conventional pillow 700 gives control to involuntary muscular activity thus improving overall height while retaining a preferred or familiar top surface.

According to FIGS. 5 and 6, when the support pillow 200 is used by the person it helps to control involuntary muscle movements during sleep or rest. According to some embodiments, the support pillow 200 may be formed of any shape or size. In an alternate embodiment, the support pillow 200 may be composed of additional or fewer components. In one of the embodiments, the support pillow 200 is designed to support any body part of the person/user in order to prevent body pain or other painful conditions such as involuntary neck muscles movement, causing the head to twist or turn to one side. In one of the embodiments, the support pillow 200 is acting as a position correction pillow to prevent involuntary muscle movements of the body parts.

As used herein, “involuntary muscle movement” refers to movement that occurs when a person moves their body in an uncontrollable and unintended way. These movements can be anything from quick, jerking tics to longer tremors and seizures. One can experience these movements in almost any part of the body, including: neck, face and limbs. The involuntary muscle movements can also be referred to as uncontrollable movement or movement disorders. These conditions result due to, but are not limited to cervical dystonia, spina bifida, Parkinson's disease, muscular dystrophy, tremor, Huntington's disease and the like.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A support pillow to control involuntary muscle movement, during sleep or rest, a support pillow comprising:
a first lateral body;
a second lateral body; and
a horizontal central strap mechanically connected to the first lateral body and the second lateral body,
wherein the first lateral body and second lateral body includes an inner layer and a plurality of pockets of a weighted material,
wherein the first lateral body and second lateral body further includes an upper side and a lower side,
wherein the horizontal central strap includes a horizontal body, a first end portion and a second end portion.

2. The support pillow to control involuntary muscle movement, during sleep or rest of claim 1, wherein the first end portion and second end portion of the horizontal central strap mechanically connects to the upper side of the first lateral body and second lateral body respectively.

3. The support pillow to control involuntary muscle movement, during sleep or rest of claim 1, wherein the plurality of pockets of the weighted material installed to an underside of the inner layer of the first lateral body and second lateral body.

4. The support pillow to control involuntary muscle movement, during sleep or rest of claim 1, wherein the horizontal central strap is constructed from a single or multilayer washable product material selected from a group of cotton, polyester, copper fabric, quilting fabric and silk.

5. The support pillow to control involuntary muscle movement, during sleep or rest of claim 1, wherein the inner layer and the plurality of pockets of the first lateral body and second lateral body of the is constructed from a single or multilayer product selected from a group of cotton, polyester, copper fabric, quilting fabric, wool, hair, feathers, polyester staple fiber, non-woven material.

6. The support pillow to control involuntary muscle movement, during sleep or rest of claim 1, wherein the weighted material filled in the plurality of the pockets of the first lateral body and second lateral body is selected from a group of polyethylene, petrochemical plastics, polypropylene and polystyrene.

7. The support pillow to control involuntary muscle movement, during sleep or rest of claim 1, wherein the weighted material is designed in a round or nearly round object or shape such as microbeads.

8. The support pillow to control involuntary muscle movement, during sleep or rest of claim 1, wherein the weighted material maintains the stability of the support pillow.

9. The support pillow to control involuntary muscle movement, during sleep or rest of claim 1, wherein the involuntary muscle movement comprise movement due to one or more disorders selected from a group comprising cervical dystonia, spina bifida, Parkinson's disease, muscular dystrophy, tremor and Huntington's disease.

10. The support pillow to control involuntary muscle movement, during sleep or rest of claim 1, wherein the support pillow acts as a position correction pillow to control involuntary muscle movements of a body parts of a person.

11. The support pillow to control involuntary muscle movement, during sleep or rest of claim 1, wherein the first lateral body and second lateral body configured to support the body parts of a person and the horizontal central strap to control displacement of the first lateral body and second lateral body from the body parts of the person.
